(19) United States
(12) Patent Application Publication
(10) Pub. No.: US 2025/0292102 A1
(43) Pub. Date: Sep. 18, 2025

(54) INTELLIGENT ANNOTATION ASSISTANT SYSTEMS AND METHODS USING PROMPT-FREE FEW-SHOT LEARNER FOR ANNOTATION AND CONFIDENT LEARNING BASED LABEL NOISE DETECTOR FOR POST-ANNOTATION

(71) Applicant: JPMorgan Chase Bank, N.A., New york, NY (US)

(72) Inventors: Hong Ni, Seattle, WA (US); Behrouz Madahian, Sammamish, WA (US)

(73) Assignee: JPMorgan Chase Bank, N.A., New York, NY (US)

(21) Appl. No.: 18/602,961

(22) Filed: Mar. 12, 2024

(51) Int. Cl. G06N 3/096; G06F 40/284; G06F 40/295; G06N 3/0455

(52) U.S. Cl. CPC G06N 3/096; G06F 40/284; G06F 40/295; G06N 3/0455

(57) ABSTRACT

Aspects of the subject disclosure may include, for example, a method including training a first machine learning model to recognize a predetermined named entity in a sentence and a corresponding label, receiving input sentences including a target named entity, receiving a plurality of few-shot examples in a support set, the plurality of few-shot examples including an annotated label for the target named entity, performing annotation on the input sentences with the trained first machine learning model using the plurality of few-shot examples and using no prompt, generating labeled data including the annotated input sentences, performing post-annotation on the labeled data with a second machine learning model that performs confident learning based label noise detection, and generating cleaned labeled data excluding one or more noisy labels from the labeled data. Other embodiments are disclosed.

### FIELD OF THE DISCLOSURE

The subject disclosure relates to intelligent annotation assistant systems and methods using prompt-free few-shot learning for annotation and confident learning based label noise detecting for post-annotation.

### BACKGROUND

Natural language processing enables computing systems to understand and interpret human language. Natural language processing (NLP) includes data annotation, which involves labeling and categorizing text data. As one example, the data annotation includes labeling a document to assign to a specific category or class. As another example, the data annotation includes identifying and labeling a particular named entity (e.g., people, locations, occupations, etc.) within a text to perform named entity recognition. As another example, the data annotation is further used for performing sentimental analysis, intent classification, etc. For instance, the data annotation analyzes customer reviews and categorize the customer reviews with labels of positive, negative, or neutral.

The data annotation is important in NLP because machine learning models are trained based on annotated data. Thus, it is essential to accurately label and classify data as noisy labels will likely directly impact a performance of machine learning models. Manually labelling and categorizing a large amount of data by human annotators, can be extremely costly and time-consuming and prone to errors or inconsistencies in the annotated data. Several data labeling tools have been used. Some conventional data labeling tools provide a graphical user interface where users can label and categorize data, which is still time consuming and costly. It is desirable to provide intelligent annotation assistant systems and methods which are designed to streamline and enhance the data annotation process. Improved intelligent annotation assistant systems and methods will likely enhance performance of NLP systems.

### BRIEF DESCRIPTION OF THE DRAWINGS

Reference will now be made to the accompanying drawings, which are not necessarily drawn to scale, and wherein:

FIG. 1 depicts label noise examples such as missing labels, wrong labels, partial labels, and inconsistent labels.

FIG. 2 is a block diagram illustrating an exemplary, non-limiting embodiment of an intelligent annotation assistant system in accordance with various aspects described herein.

FIG. 3 depicts an illustrative embodiment of few-shot leaning techniques in accordance with various aspects described herein.

FIG. 4 depicts an illustrative embodiment of prompt-free few-shot leaning techniques in accordance with various aspects described herein.

FIG. 5 depicts an illustrative embodiment of confident learning based label noise detection techniques in accordance with various aspects described herein.

FIG. 6 depicts an illustrative embodiment of a confident learning based label noise detection method in accordance with various aspects described herein.

FIG. 7A depicts an exemplary performance of the prompt-free few-shot learning algorithm as shown in FIG. 4.

FIG. 7B depicts an exemplary performance of a prompt-free few-shot learning algorithm using loose metrics as shown in FIG. 4.

FIG. 8A depicts an exemplary performance of a confident learning based label noise detection method with a first model in accordance with various aspects described herein.

FIG. 8B depicts an exemplary performance of a confident learning based label noise detection method with a second model in accordance with various aspects described herein.

FIG. 8C depicts an exemplary performance of a confident learning based label noise detection method with a third model in accordance with various aspects described herein.

FIG. 8D depicts an exemplary performance of a confident learning based label noise detection method with a fourth model in accordance with various aspects described herein.

FIG. 8E depicts an exemplary performance of a confident learning based label noise detection method based on a number of iterations in accordance with various aspects described herein.

FIG. 9 depicts an exemplary embodiment of a comprehensive intelligent annotation method in accordance with various aspects described herein.

### DETAILED DESCRIPTION

The subject disclosure describes, among other things, illustrative embodiments for intelligent annotation assistant systems and methods using artificial intelligence or machine learning techniques to generate annotated data in a speedy, cost effective manner and at the same time, to reduce label errors in the generated annotated data. The intelligent annotation assistant systems and methods utilize the artificial intelligence or machine learning techniques for annotation and post-annotation. For the artificial intelligence or machine learning techniques, the intelligent annotation assistant systems and methods utilize prompt-free few-shot learning techniques for annotation and confident learning based label noise detection techniques for post-annotation. Other embodiments are described in the subject disclosure.

One or more aspects of the subject disclosure are directed to a method including steps of: receiving, by a processing system including a processor, input text data including a named entity, receiving, by the processing system, a plurality of few-shot examples in a support set, the plurality of few-shot examples corresponding to a plurality of predetermined labels, performing, by the processing system, annotation of the input text data using a few-shot learning algorithm using the plurality of few-shot examples, generating, by the processing system, labeled data including the annotated input text data, identifying, by the processing system, a label noise on the labeled data using a confident learning based label noise detection algorithm, and generating, by the processing system, cleaned labeled data excluding one or more noisy labels from the labeled data.

One or more aspects of the subject disclosure are directed to a non-transitory machine-readable medium, comprising executable instructions that, when executed by a processing system including a processor, facilitate performance of operation. The operations include training a first machine learning model to recognize a predetermined named entity in a sentence and a corresponding label, receiving input sentences including a target named entity, receiving a plurality of few-shot examples in a support set, the plurality of few-shot examples including annotated labels for the target named entity, performing annotation on the input sentences with the trained first machine learning model using the plurality of few-shot examples and using no prompt, generating labeled data including the annotated input sentences, performing post-annotation on the labeled data with a second machine learning model that performs confident learning based label noise detection, and generating cleaned labeled data excluding one or more noisy labels from the labeled data.

One or more aspects of the subject disclosure are directed to a device including a processing system including a processor, and a memory that stores executable instructions that, when executed by the processing system, facilitate performance of operations. The operations include training a few-shot learning model to recognize a predetermined named entity in a sentence and a corresponding label without a prompt, receiving input sentences including a target named entity, receiving a plurality of few-shot examples in a support set, the plurality of few-shot examples including annotated labels for the target named entity, predicting annotation on the input sentences with the trained few-shot learning model, generating labeled data including the annotated input sentences, identifying a label noise on the labeled data using a confident learning based label noise detection model, and generating cleaned labeled data excluding one or more noisy labels from the labeled data.

A natural language processing (NLP) system operates to perform various tasks such as intent classification, keyword extraction, named entity recognition, sentimental analysis, etc. For an intent classification application, a speaker who provides an audio input to an automatic speech recognition engine has a certain intent and the NLP system attempts to understand the intent in order to provide the most relevant response or take a relevant action. For keyword extraction or named entity recognition, a user types a query or question in natural language and searches the Internet. For instance, a user's query is “where was Trump born?” Alternatively, a user speaks a query, “where was Trump born?” The NLP system can extract keyword or recognize named entity (i.e., Trump). As further another example, sentiment analysis is another application of NLP which tries to understand sentiment of speakers, users, customers, etc. (e.g., opinions and stances) through NLP on web, social media, other online sources, etc.

The present disclosure is directed to named entity recognition performed by the NLP system. Performance of the NLP system may rely on a quality of annotated data via a data annotation process. Data labeling is a fundamental step in the data annotation process. The data labeling can be time consuming and an expensive endeavor involving a vast amount of data and a large number of human annotators. Furthermore, human annotators may use inconsistent or incorrect labels and be prone to errors.

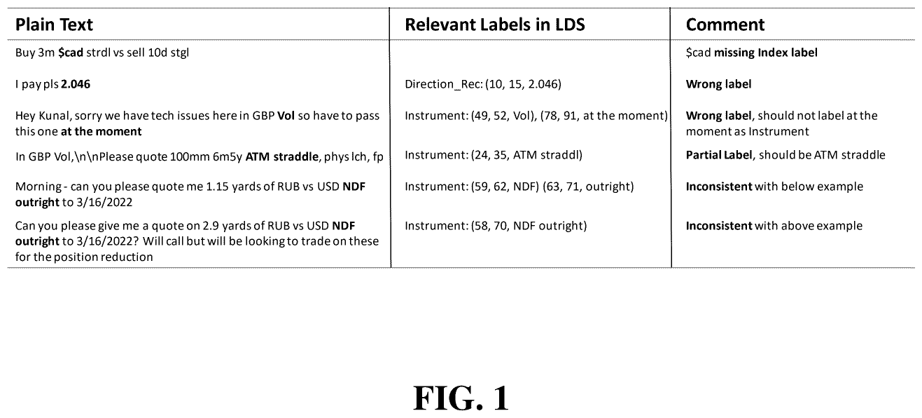

Despite efforts to ensure a quality of annotated data, noisy labels may result in suboptimal NLP system performance. FIG. 1 depicts label noise examples such as missing labels, wrong labels, partial labels, and inconsistent labels. Referring to the examples in FIG. 1, with respect to various plain texts, labels can be missing, incorrect, incomplete or partial, inconsistent, etc.

An artificial intelligence model or a machine learning model (hereinafter collectively machine learning model) is used to enhance and improve the data labeling. In order to handle noisy labels, a model-centric approach or a data-centric approach is available. The model-centric approach introduces a new machine learning model or a new loss function to reduce the effect of noisy labels. See Jacob Goldberger et al., “Training Deep Neural-Networks Using A Noise Adaption Layer, ICLR 2017; Lu Jiang, et al., “MentorNet: Learning Data-Driven Curriculum for Very Deep Neural Networks on Corrupted Labels, arXiv:1712.05055v2 (Aug. 13, 2018); Bo Han, et al., “Co-teaching: Robust Training of Deep Neural Networks with Extremely Noisy Label, 32^{nd} Conference on Neural Information Processing Systems (NeurIPS 2018), Montreal, Canada. The model-centric approach facilitates robust learning without knowing which example is mislabeled. The data-centric approach is agnostic to a machine learning model and can identify which example is mislabeled. See Curtis G. Northcutt et al., “Confident Learning: Estimating Uncertainty in Dataset Labels,” arXiv:1911.00068v6 [stat.ML] (Aug. 22, 2022).; Hongyi Zhang, mixup: Beyond Empirical Risk Minimization, arXiv:1710.09412v2 (Apr. 27, 2018). The data-centric approach can be combined with the model-centric approach to achieve a better performance.

Currently, there may be no systematic and easy-to-use tool which is available to resolve or alleviate the burden of noisy label identification. For instance, currently available solutions include Frequency Counts, Regular Expressions (RegEx), Model Error Analysis, Manual Label Checking, etc. Frequent Counts involve counting occurrences of words in the text or document. Regular Expressions involve a sequence of characters that are mainly used to find or replace patterns present in the text, such as “*,” “?,” etc. Model Error Analysis involves automatic tools to aid to break down model's errors into meaningful groups to analyze the errors and highlight the most frequent type of errors. Manual labeling involves the process of assigning labels to data by a human annotator, which may be time-consuming and prone to errors or inconsistencies by the human annotator.

The currently available solutions have various limits such as purely manual, time consuming, project dependent, a limited coverage, a low hit rate, etc. It is desirable to build an automated machine learning tool to discover a potential label noise in large-labeled datasets. Accordingly, the present disclosure is directed to intelligent annotation assistant systems and methods which are designed to streamline and enhance a data annotation process including data labeling. The present disclosure is further directed to the intelligent annotation assistant systems and methods using machine learning techniques to analyze data and predict data labeling. The present disclosure is further directed to the intelligent annotation assistant systems and methods for generating data labeling for named entity recognition.

In various embodiments, the intelligent annotation assistant systems and methods utilizes machine learning techniques which include a first component for annotation and a second component for post-annotation. The first component includes prompt-free few-shot learner techniques. Few-shot learning techniques are based on a machine learning framework that enables a pre-trained model to generalize over new categories of data that the pre-trained model has not seen during training using only a few labeled samples per class. The few labeled samples per class are contained in a support set, where a number of classes (m) and a number of samples (n) per class are referred to as m-way n-shot and describes a framework of few-shot learning. The few-shot learning techniques may drastically reduce the time and effort required for data annotation. Instead of manually annotating an entire dataset, a handful of annotated examples are provided instead. The few-shot learning techniques then uses these examples to pre-annotate the rest of the dataset, thereby significantly accelerating the annotation process.

The second component of the machine learning techniques used in the intelligent annotation assistant system and method includes confident learning based label noise detection techniques Curtis G. Northcutt et al., “Confident Learning: Estimating Uncertainty in Dataset Labels,” arXiv:1911.00068v6 [stat.ML] (Aug. 22, 2022). The confident learning based label noise detection techniques are designed to improve the quality of the annotated data by identifying label errors. By locating these errors in a timely manner, the label noise detection techniques ensure that the annotated data is as accurate and reliable as possible.

In various embodiments according to the present disclosure, the first and the second components together form a comprehensive machine learning tool suite for data annotation. The intelligent annotation assistant systems and methods according to the present disclosure can not only save time and effort but also enhance the quality of the annotated data, making it an invaluable asset for any downstream NLP project that relies on annotated data by the machine learning techniques.

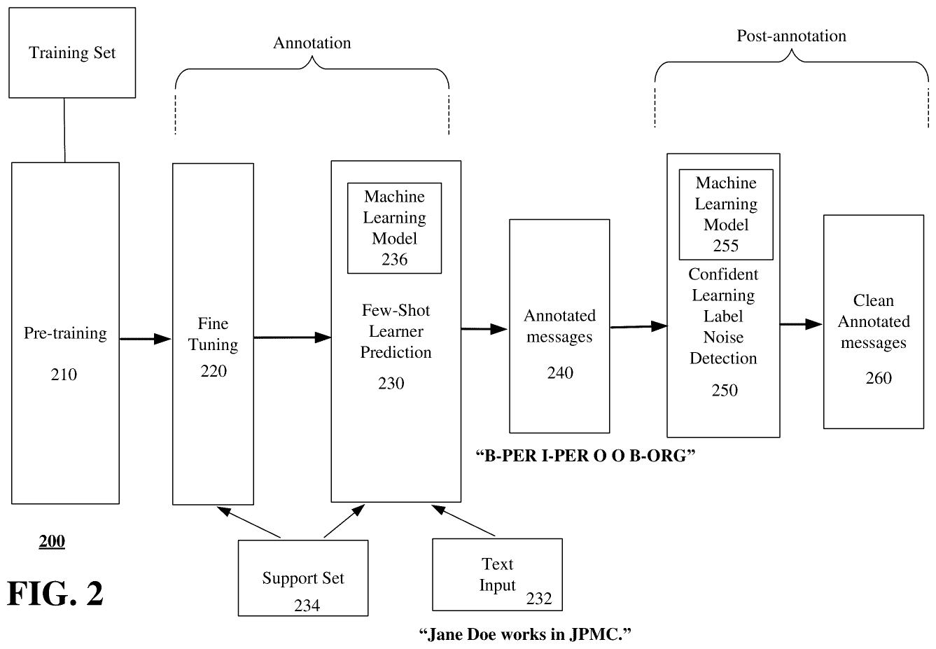

FIG. 2 is a block diagram illustrating an exemplary, non-limiting embodiment of an intelligent annotation assistant system 200 in accordance with various aspects described herein. In various embodiments, the intelligent annotation assistant system 200 includes a pre-training stage 210, a fine-tuning stage 220, a few-shot learner prediction stage 230 and a confident learning based label noise detection stage 250. The system 200 is designed to receive text data input such as text messages, chat messages, text transcription converted from speech, etc. The system 200 is further designed to output annotated messages. Annotated messages 240 are generated after an annotation phase and clean annotated messages 260 are generated after a post-annotation phase. The annotated messages 240 correspond to labeled data which will be further refined to become clean labeled data via the confident learning based label noise detection 250.

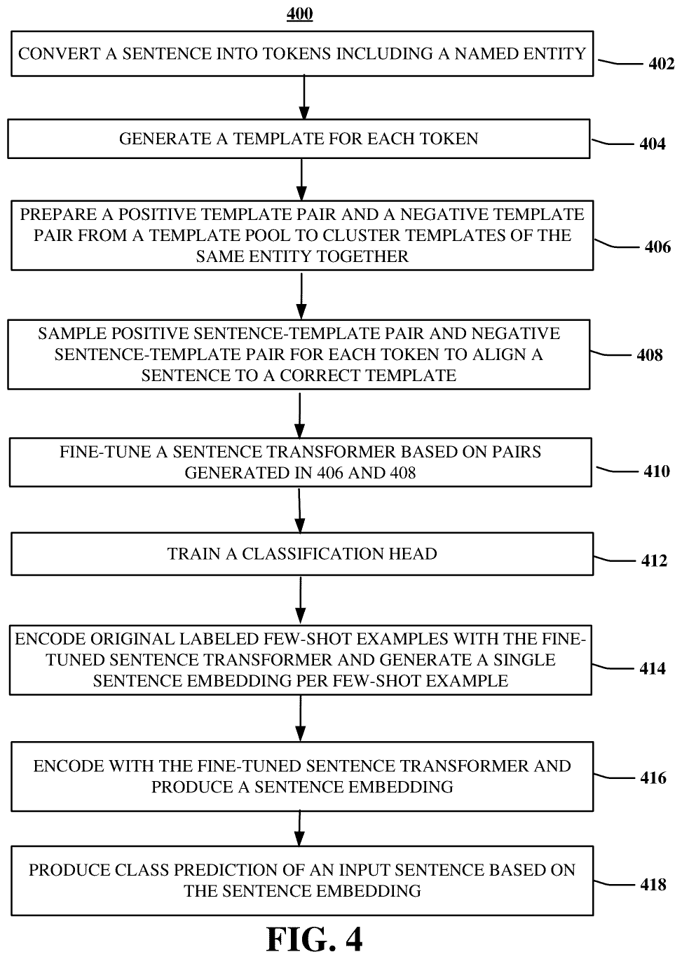

In various embodiments, the intelligent annotation assistant system 200 performs data annotation for named entity recognition. As one example, with respect to a text input of “Jane works in JPMC,” the intelligent annotation assistant system 200 performs data annotation to generate labeled data such as [Jane, Person] and [JMPC, Organization]. As depicted in FIG. 2, the pre-training stage 210 may use a large scale of datasets to train a machine learning (ML) model. The training datasets include text input such as sentences, “Jane Doe works in JPMC.” Elements of the sentence can be associated with labels such as “Person,” “Organization,” etc. for named entity recognition. The ML model is trained to learn similarities between named entities contained in input sentences and corresponding labels such as Jane-Person. In some embodiments, the ML model may be implemented with a convolutional neural network to extract features from the named entities, such as “Jane.” In various embodiments, the ML model may be implemented with sentence transformers, which will be described below in connection with FIG. 4. The pre-training stage 210 may utilize standard supervised learning techniques or Siamese network techniques which are available in the art.

In various embodiments, the intelligent annotation assistant system 200 (“the system 200”) utilizes few-shot learning techniques 230. The few-shot learning techniques correspond to a machine learning framework that enables a pre-trained ML model to generalize over new data that the pre-trained model has not seen during training, using only a few labeled samples per class. As depicted in FIG. 2, few-shot learning uses a support set 234. The support set 234 includes a few labeled samples per new category of data, which the pre-trained model (at 210) will use to generalize on new data. In some embodiments, the support set 234 includes a few samples annotated by human. The text input 232 includes samples from new and old data on which the pre-trained ML model from the pre-training stage 210 needs to generalize using knowledge and information gained from the support set. Using the few-shot learning techniques, the pre-trained NPL model, trained via the pre-training (210), can be extended to new data and therefore, there is no need to retrain a model, which can lead to saving of computation resources. The few-shot learning techniques may also enable the system 200 to learn about new data with a relatively few number of samples contained in the support set 234.

In various embodiments, the few-shot learning techniques enables the system 200 to learn similarity functions that can map the similarities between the classes in the support set 234 and named entities included in the text input 232. The similarity functions typically outputs a probability value for the similarity. At the pre-training stage 210, a large-scale labeled dataset can be used to train the similarity function and the pre-trained model is trained to learn similarities in a supervised fashion using the large-scale labeled dataset. Once the similarity function is trained, a ML model 236 can be used in the few-shot learning phase 230 for determining similarity probabilities on the text input 232 by using the support set 224. For instance, “Samantha” is a named entity contained in the text input 232, and labels, such as persons, occupations, locations, can be included in the support set 234. The ML model 236 can infer and predict, based on similarities, persons rather than occupations, locations, etc. as a label for the named entity, “Samantha.” The few-shot learning techniques may involve two inputs or three inputs and use pairwise similarity or triple loss, respectively.

The system 200 can be implemented for various use cases. As an exemplary use case, traders use chat applications to type messages about trades with external clients. Messages from traders contain trade related entities, such as Counter Party, Start Date, Size, Price, etc. which can be potentially new classes. For annotating these messages, thousands of messages with manual labels may be needed. Instead of performing manual labeling of thousands of messages, the few-shot learning prediction stage 230 operates with a few manually labeled examples. Based on the pre-training (210), the trained ML model 236 can make a prediction of labels relevant to the named entities in the text input 232 by comparing against the few labeled samples in the support set 234. As a result, the annotated messages 240 are generated. Additionally, human annotators can check the annotated messages 240 via the few-shot learning techniques and exclude inaccurate results, such as certain entities, from the annotated messages 240.

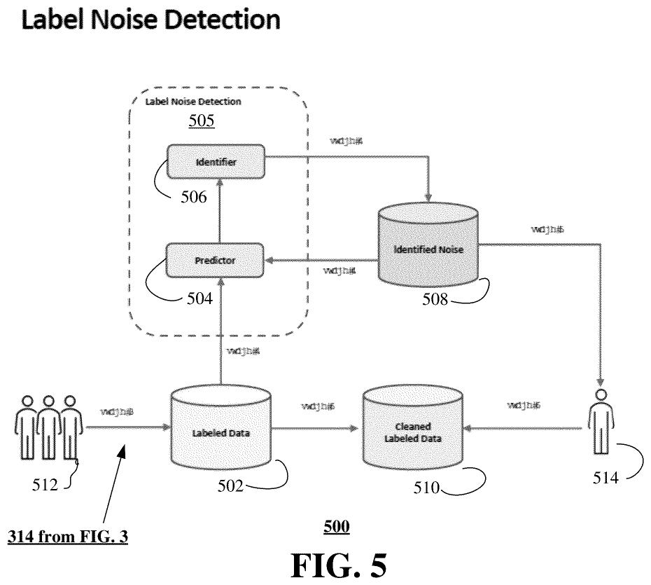

The annotated messages 240 will be subject to confident learning based label noise detection 250 in order to detect a potential label noise, thereby improving the quality of annotated data. The confident learning based label noise detection techniques will be described below in connection with FIG. 5. As result, clean annotated messages 260 are output.

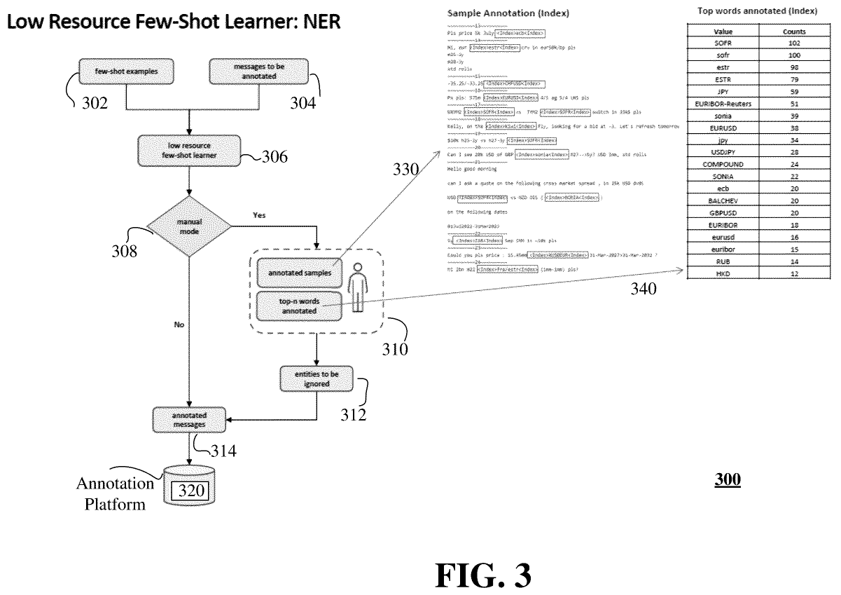

FIG. 3 depicts an illustrative embodiment of few-shot leaning techniques in accordance with various aspects described herein. In various embodiments, during the training phase, the machine learning model 236 (depicted in FIG. 2) has been pre-trained to learn similarities between named entities and corresponding labels. Accordingly, the machine learning model 236 has been pre-trained to learn for untrained or new classes and can infer and predict labels for untrained or new classes.

In various embodiments, during an inference stage, the machine learning model 236 receives messages to be annotated (304). For instance, the messages to be annotated include various forms of text input, such as chat messages typed by traders on trades with external clients. As one example, the messages to be annotated (304) include trade related entities such as Counter Party, Start Date, Size, Price, etc. The few-shot examples 302 may include a few classes that may or may not match with the trade related entities. The few-shot examples 302 includes a few human annotated messages included in a support set. The few human annotated messages may include entities that are not a part of the pre-training. The machine learning model 236 compares messages to be annotated 304 against the few-shot examples 302 in the support set and predicts labels corresponding to named entities in the messages to be annotated 304.

In various embodiments, the machine learning model 236 makes a prediction on the messages to be annotated 304. As a result of the few-shot learning techniques, sample annotation 330 marked with index is generated as depicted in FIG. 3. Top-n words annotated 340 can be identified and sorted based on their occurrence counts. As one example, the messages to be annotated 304 may include a large number of messages. Instead of manual labeling by human annotators, the intelligent annotation assistant system 200 generates annotated messages 240 using the few-shot learning techniques, as depicted in FIG. 2.

Referring back to FIG. 3, in various embodiments, a manual mode 308 can be activated such that human annotators can check the annotated samples via the few-shot learning techniques as initial annotations. The manual mode 308 is optional and can be activated or deactivated based on users' selection. In some embodiments, when the manual mode 308 is on, some entities 312 can be ignored based on a check by human annotators. For instance, the machine learning model 236 operates to predict labels, Person and Location. Using the few-shot learning techniques, the messages to be annotated 304 will include annotations corresponding to Person and Location. When the manual mode 308 is on, human annotators can check the annotation results and may find that the annotation results on Location are poor. Then human annotators may decide to exclude the annotation results on Location. Thus, only the annotation results on Person will be stored. When the manual mode 308 is off, the annotation results on Location and Person will be stored. As a result, annotated messages 314 are output. In some embodiments, the annotated messages 314 may have a predetermined file format such as a JSON (JavaScript Object Notation) file. The annotated messages 314 are uploaded to an annotation platform 320.

FIG. 4 depicts an illustrative embodiment of prompt-free few-shot leaning techniques in accordance with various aspects described herein. In large language model (LLM) applications, the few-shot learning techniques show great potential of alleviating the burden of data sparsity. However, LLM's capability of the few-shot learning techniques relies heavily on carefully curated prompts. Also, there is no universal way of prompting LLMs: the prompts that work for OpenAI models may not work for Llama models. Despite the issue of prompts, two other main issues that usually limits the usage of LLMs are data security and computation power.

In various embodiments, the few-shot learning techniques 300 for use with the intelligent annotation assistant system 200 utilizes a prompt-free framework. Few-shot learning techniques without prompts have been proposed. Lewis Tunstall, et al., “Efficient Few-Shot Learning Without Prompts,” arXiv:2209.11055v1 [cs.CL] (Sep. 22, 2022)(“the Tunstall Paper”). In the Tunstall Paper, the prompt-free framework utilizes sentence transformers which modify pretrained transformer models by using Siamese and triplet network structures. In the Tunstall Paper, the prompt-free framework includes fine-tuning sentence transformers on input data by using contrastive, Siamese training on sentence pairs. Then the prompt-free framework trains a text classification head using the encoded training data generated by the fine-tuned sentence transformers. The classification head of the sentence transformers converts a sequential output of the sentence transformers into a classification result.

The prompt-free few-shot learning framework in the Tunstall Paper works for sequence classification (e.g., sentiment classification) and not token classification (e.g., named entity recognition). The present disclosure focuses on the token classification for the named entity recognition by using the fine-tuned sentence transformers as a backbone for the annotation tool (i.e., the few-shot learning techniques).

During a training phase, sentence transformers encode each sentence to a fixed length vector. Due to this nature of sentence transformers, sentence transformers fine tuning may not be used for the token classification, as the position information of each token is missing. To overcome this issue, a divide and conquer-like approach is implemented as follows:

Original Sentence: Jane Doe works in JPMC

BIO (Begin, Interior, Out) Labels: B-PER (Person) I-PER (Person) O O B-ORG

| [symbol] | Jane | Doe | works | in | JPMC |
|---|---|---|---|---|---|
| | \| | \| | \| | \| | \| |
| [symbol] | B-PER | I-PER (Person) | 0 | 0 | B-ORG |

As depicted in FIG. 4, an input sentence is converted into tokens potentially including a named entity (e.g., Jane/Doe/works/in/JMPC) (Step 402). A template for each token is generated (Step 404) as shown with the example below. The position information of each token and a label are associated with each token.
Template 1: <-B-PER-> Doe works in JPMC
Template 2: Jane <-I-PER-> works in JPMC
Template 3: Jane Doe <-O-> in JPMC
Template 4: Jane Doe works <-O-> JPMC
Template 5: Jane Doe works in <-B-ORG->

At Step 406, a first pair of sample positive template-template pair and a second pair of negative template-template pair for each token are prepared from a template pool. Templates of the same entity are clustered together (Step 406). Taking “Jane” as an example, a placeholder below means an entity name other than <B-PER>.
a positive template-template pair example: <-B-PER-> Doe works in JPMC & <-B-PER-> Doe is the CEO;
a same sentence negative template-template pair example: <-B-PER-> Doe works in JPMC & Jane <-placeholder-> works in JPMC; and
a different sentence negative template-template pair example: <-B-PER-> Doe works in JPMC & John Doe <-placeholder-> the CEO.

As Step 408, a positive sentence-template pair and a negative sentence-template pair for each token are sampled to align a sentence to a correct template. Taking “Jane” as an example, a placeholder below means an entity name other than B-PER.
a positive sentence-template pair example: <-Jane-> Doe works in JPMC & <-B-PER-> Doe works in JPMC
a negative sentence-template pair example: <-Jane-> Doe works in JPMC & <-placeholder-> Doe works in JPMC

In Step 410, the sentence transformer is fine-tuned based on the sentence pairs generated in Step 406 and Step 408 by using a contrastive training approach. The contrastive learning techniques are a learning approach that focuses on extracting meaningful representations by contrasting positive and negative pairs of instances. The contrastive learning techniques leverage the assumption that similar instances should be closer together in a learned embedding space, while dissimilar instances should be farther apart. The contrastive learning applied to NER models enables representation of entity types to be similar with a corresponding entity spans, and to be dissimilar with that of other text spans such as non-entity spans.

In Step 412, a classification head is trained. The fine-tuned sentence transformer encodes original labeled few-shot examples and generate a single sentence embedding per few-shot examples (Step 414). The embeddings, along with their class labels, form a training set for the classification head. A logistic regression model is used as the text classification head.

| x | y |
|---|---|
| <-Jane-> Doe works in JPMC | B-PER |
| Jane <-Doe-> works in JPMC | I-PER |
| Jane Doe <-works-> in JPMC | O |
| Jane Doe works <-in-> JPMC | O |
| Jane Doe works in <-JPMC-> | B-ORG |

During an inference phase, the fine-tuned sentence transformer encodes an unseen input sentence and produces a sentence embedding (Step 416). The classification head trained in Step 412 produces a class prediction of the input sentence based on its sentence embedding (Step 418). An example is described as follows:
Original sentence: Who is the CEO of JPMC

The original sentence is converted into following sentences, and make a prediction for each sentence, then aggregate the predictions to form the final output.
<-Who-> is the CEO of JPMC [symbol] O.
Who <-is-> the CEO of JPM [symbol] O.
Who is <-the-> CEO of JPMC [symbol] O.
Who is the <-CEO-> of JPMC [symbol] O
Who is the CEO <-of-> JPMC [symbol] O
Who is the CEO of <-JPMC-> [symbol] B-ORG

In the above described embodiments, the intelligent annotation assistant system performs few-shot learning by eliminating a need for manually written prompts, typically required by large language models like ChatGPT. The intelligent annotation assistant system leverages sentence transforms, which may be originally designed to encode sentence level information into fixed-size vectors, in a new way to perform named entity recognition tasks without prompts, increasing efficiency and mitigating potential security risks associated with confidential data. The sentence transformer fine tuning package, which is available in the art, (https://github.com/huggingface/setfit), can be used in implementing the few-shot learning techniques.

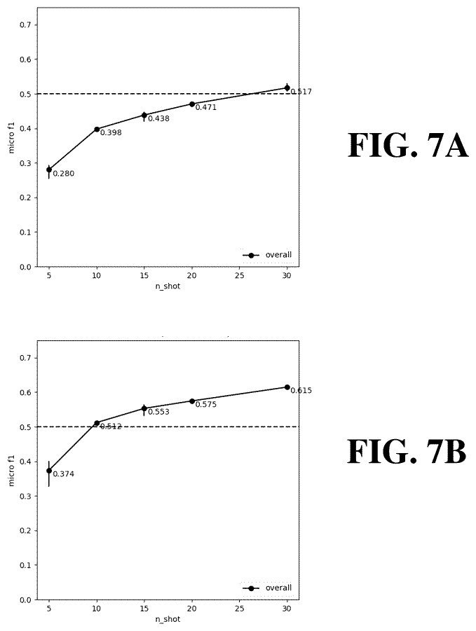

FIG. 7A depicts an exemplary performance of the prompt-free few-shot learning algorithm as depicted in FIG. 4 with regard to named entity recognition tasks. FIG. 7B depicts an exemplary performance of the prompt-free few-shot learning algorithm using loose metrics as depicted in FIG. 4 with regard to named entity recognition tasks. FIGS. 7A and 7B show the performance using f1 score of the few-shot learning algorithms as a function of number of human annotated examples provided (n_shot) in the support set. In FIG. 7B, loose metrics are used to account for a partially correct prediction for named entity recognition. For example, if “IRS FLY” should be labeled as a particular instrument, and the annotation result is “IRS” as Instrument and “FLY” as Instrument, then the predictions can be considered correct under the loose metrics. The few-shot learning techniques are used for annotation and therefore, a partially correct prediction can potentially save time and resources.

Referring back to FIG. 2, in various embodiments, the intelligent annotation assistant system utilizes confident learning (“CL”) based label noise detection techniques for post-annotation (250). A machine learning model 255 performs the CL based noise detection techniques. Using the CL label noise detection techniques described in the Curtis Paper, the machine learning model 255 identifies label errors in datasets by pruning noisy data, counting with probabilistic thresholds to estimate noise, and ranking examples to train with confidence.

The confident learning does not require prior knowledge regarding uncorrupted labels. As described in the Curtis Paper, joint distribution between noisy labels (given) and uncorrupted labels is estimated. The CL label noise detection techniques identifies noisy labels in existing datasets to improve learning with noisy labels. The Curtis Paper, p. 1377. More specifically, the CL label noise detection techniques include three steps, characterizing class-conditional label noise, removing noisy examples, training with removed errors, reweighting examples by class weight. The Curtis Paper, p. 1377.

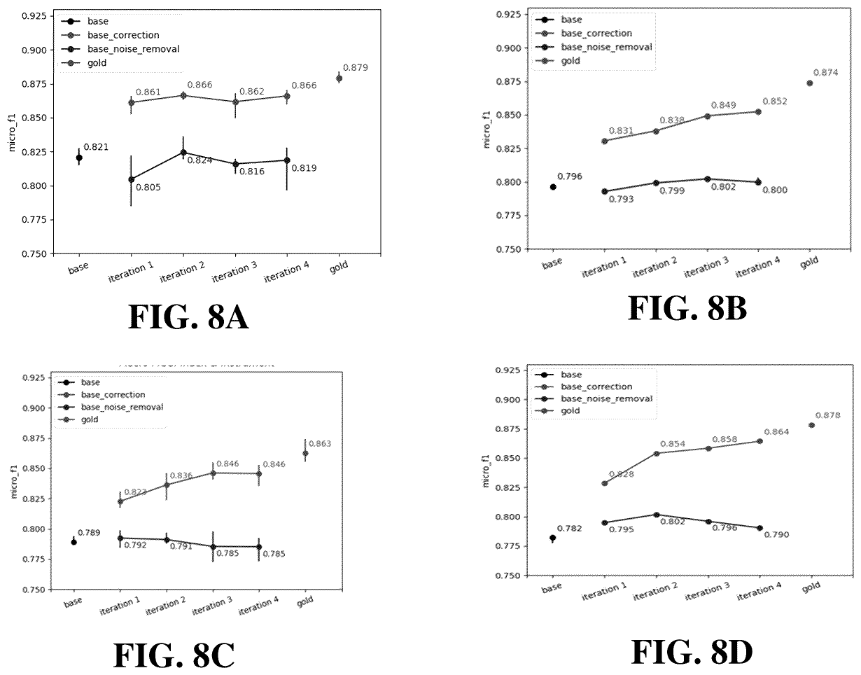

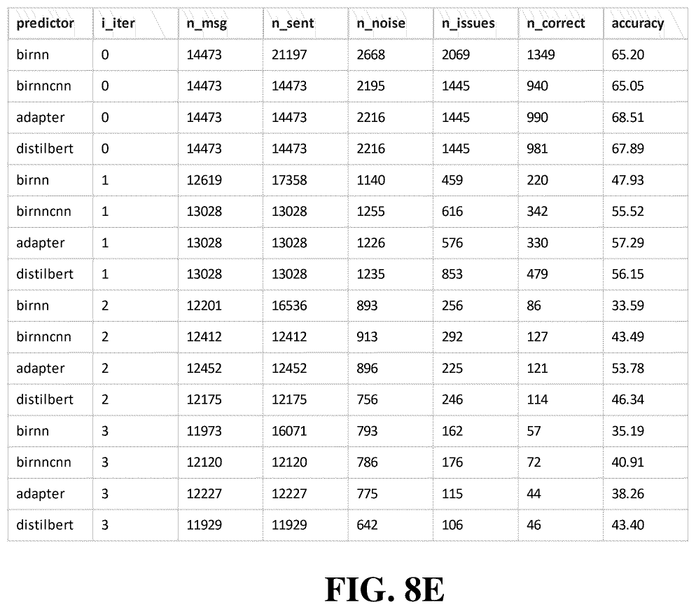

FIG. 5 depicts an illustrative embodiment of a CL based label noise detection stage in accordance with various aspects described herein. As depicted in FIG. 2, the intelligent annotation assistant system utilizes the CL based label noise detection techniques for post-annotation (250). In various embodiments, during a training phase, initially annotated messages are provided from human annotators 512. Alternatively, the initially annotated messages, as a result of the prompt-free few-shot learning, can be provided to the machine learning model 252. The initially annotated messages correspond to labeled data 502. The labeled data are provided to a machine learning model 505 such as the model 255 depicted in FIG. 2. The machine learning model 505 includes a predictor 504 and an identifier 506. The predictor 504 is configured to predict a list of examples that could contain noisy label(s) among the labeled data. The identifier 506 is configured to identify noisy labels among the list of examples. A number of iterations can be set to perform the prediction and identification of potential label noises, as depicted in FIG. 8E.

In various embodiments, the identified noise 508 is provided to human annotators 514 who can manually check the identified noise for validation and/or correction. Accordingly, cleaned labeled data 510 is obtained. Users can choose a predictor model, among different model types, which works the best for use cases.

In various embodiments, different models such as Bidirectional Recurrent Neural Network (BiRNN), Bidirectional Recurrent Neural Network Convolutional Neural Network (BiRNNCNN), DistilBERT, a distilled version of BERT (Bidirectional Encoder Representations from Transformers) and DistilBERT with Adapter fine-tunning are supported as backbone predictors, accommodating diverse needs.

In various embodiments, during an inference phase, the trained predictor 504 will make prediction on the messages based on the CL label noise detection techniques. The machine learning model 505 using the CL label noise detection techniques will use predicted probabilities to identify the messages that contain labeling noises. With respect to the machine learning model 505 using the CL label noise detection techniques, users only need to provide the manually labeled messages 502 and select a model type. Then machine learning model 505 in the label noise detection stage will suggest messages with a label noise.

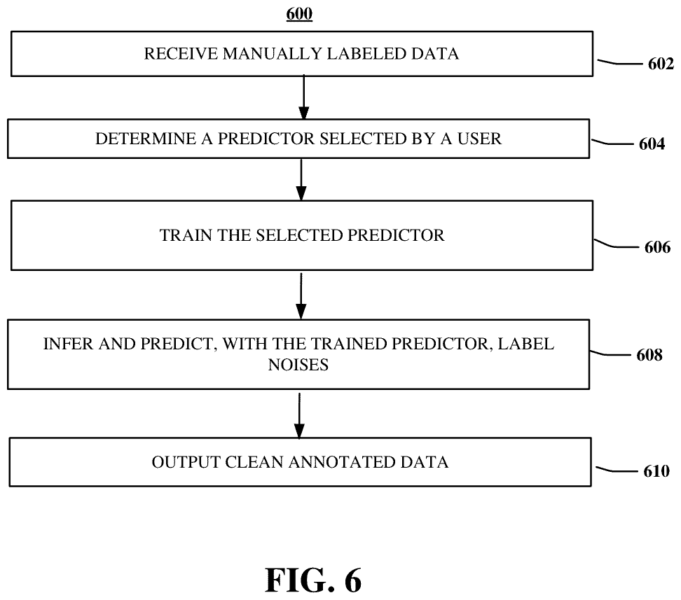

FIG. 6 depicts an illustrative embodiment of a confident learning based label noise detection method 600 in accordance with various aspects described herein. In various embodiments, the method 600 includes providing manually labeled data to a predictor (Step 620) and determining the predictor selected by a user (Step 604). The method 600 further includes training the selected predictor (Step 606) and inferring and predicting, with the trained predictor, label noises (Step 608). The method includes identifying a list of examples that could contain noisy label (Step 608). As a result, cleaned labeled data is obtained and output (Step 610).

FIG. 8A depicts an exemplary performance of a confident learning based label noise detection method with a first model in accordance with various aspects described herein. FIG. 8B depicts an exemplary performance of a confident learning based label noise detection method with a second model in accordance with various aspects described herein. FIG. 8C depicts an exemplary performance of a confident learning based label noise detection method with a third model in accordance with various aspects described herein. FIG. 8D depicts an exemplary performance of a confident learning based label noise detection method with a fourth model in accordance with various aspects described herein. By way of example, the first model includes BiRNN, the second model includes BiRNNCNN, the third model includes DistilBERT+Adapter fining tuning, and the fourth model includes DistilBert+Full filing tuning. FIG. 8E depicts an exemplary performance of the CL based label noise detection using different models used for the predictor, a number of iterations and accuracy.

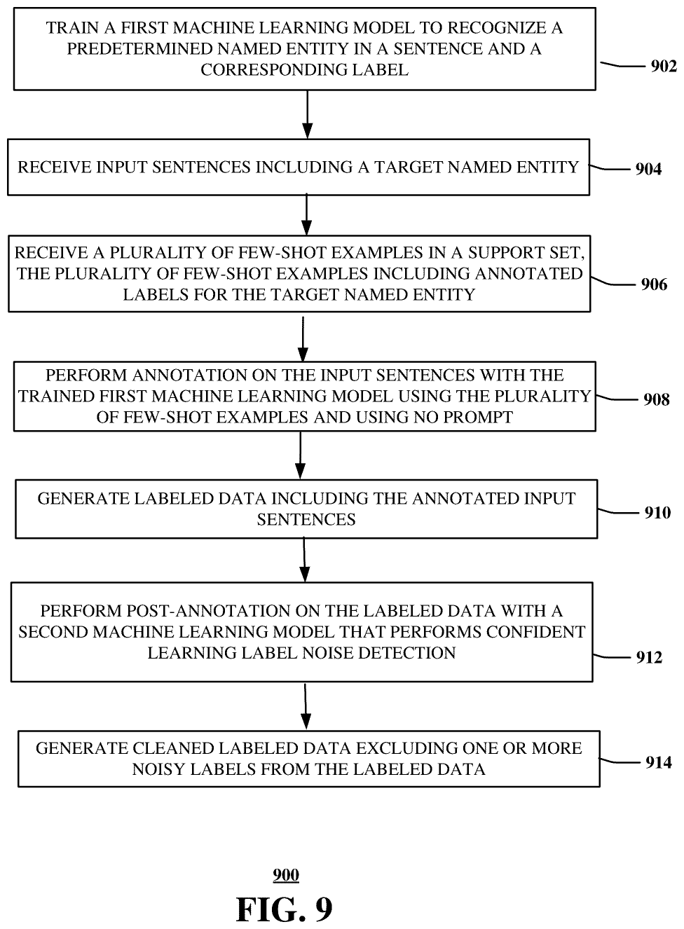

FIG. 9 depicts an illustrative embodiment of a method in accordance with various aspects described herein. In various embodiments, the method 900 includes training a first machine learning model to recognize a predetermined named entity in a sentence and a corresponding label (Step 902), receiving input sentences including a target named entity (Step 904), receiving a plurality of few-shot examples in a support set, the plurality of few-shot examples including annotated labels for the target named entity (Step 906), performing annotation on the input sentences with the trained first machine learning model using the plurality of few-shot examples and using no prompt (Step 908), generating labeled data including the annotated input sentences (Step 910), performing post-annotation on the labeled data with a second machine learning model that performs confident learning label noise detection (Step 912), and generating cleaned labeled data excluding one or more noisy labels from the labeled data (Step 914).

In various embodiments, the generating the labeled data (Step 910) further comprises annotating each sentence included in the input text data to recognize the named entity and mark the named entity with a corresponding label and positional information of the named entity in each sentence. The performing the annotation (Step 908) further comprises performing the annotation using prompt-free few-shot learning algorithm which is using no manually drafted prompt.

In various embodiments, the method 900 further includes pre-training the first machine learning model that implements the few-shot learning algorithm using a train dataset, wherein the train dataset is greater than the plurality of few-shot examples, and fine-tuning the first machine learning model using the plurality of few-shot examples.

In various embodiments, the training the first machine learning model (Step 902) further includes tokenizing each sentence included in the input text data into one or more tokens, generating a template for each of the one or more tokens, sampling a first pair including a positive template and the template and a second pair including a negative template and the template from a templates pool, sampling a third pair including a positive sentence template and the template and a fourth pair including a negative sentence template and the templates for each token, fine-tuning the first machine learning model based on the first pair, the second pair, the third pair and the fourth pair, and training a classification head of the first machine learning model.

In various embodiments, the method 900 further includes receiving a new input sentence, tokenizing the new input sentence, converting the new input sentence into a templates set, each template of the templates set corresponding to each token of the new input sentence, predicting a label and position information on each token of the new input sentence using the trained and fine-tuned first machine learning model, aggregating the predicted label and position information, and generating a final output.

In various embodiments, the method 900 further includes training a second machine learning model that implements the confident learning based label noise detection algorithm, and predicting and identifying, by the processing system, a label noise on the labeled data with the trained second machine learning model.

The method 900, using dual-function tools, i.e., the few-shot learning and the label noise detecting techniques, streamlines both annotation and post-annotation processes, thereby providing a comprehensive, innovative, and secure solution in the machine learning field.

In the above-described embodiments, unlike most tools in the market that covers only parts of the annotation cycle, a comprehensive annotation system and method is provided to streamline and improve the accuracy of annotation, playing a crucial role throughout a life cycle of annotation. The comprehensive annotation system and method effectively minimizes the laborious tasks associated with annotations while assuring top-notch quality. Unlike conventional systems, the intelligent annotation assistant system and method described in the present disclosure does not rely on manually written prompts, thereby saving considerable time and reducing errors related to human inputs. This feature can seamlessly handle and process confidential data for both classification and named entity recognition tasks, allowing it to be adaptable to a wide array of data sets and ensure the privacy of information. In the post-annotation phase, the annotation system and method unlocks the capability of label noise detection. In various embodiments, the label noise detection is equipped with four distinct model types, making it thoroughly versatile to handle various diverse use cases. The comprehensive annotation system and method helps to detect any inconsistencies or errors in the labeled data that could possibly affect the final outcome of data processing. The comprehensive annotation system and method may ensure that the resulting annotations are precise, consistent, and reliable, thereby leaning to more accurate and actionable insights.

While for purposes of simplicity of explanation, the respective processes are shown and described as a series of blocks in FIGS. 4-6 and 9, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
receiving, by a processing system including a processor, input text data including a named entity;
receiving, by the processing system, a plurality of few-shot examples in a support set, the plurality of few-shot examples corresponding to a plurality of predetermined labels;
performing, by the processing system, annotation of the input text data using a few-shot learning algorithm using the plurality of few-shot examples;
generating, by the processing system, labeled data including the annotated input text data;
identifying, by the processing system, a label noise on the labeled data using a confident learning based label noise detection algorithm; and
generating, by the processing system, cleaned labeled data excluding one or more noisy labels from the labeled data.

2. The method of claim 1, wherein the generating the labeled data further comprises annotating each sentence included in the input text data to recognize the named entity and mark the named entity with a corresponding label.

3. The method of claim 1, wherein the performing the annotation using the few-shot learning algorithm further comprises performing the annotation using prompt-free few-shot learning algorithm which is using no manually drafted prompt.

4. The method of claim 3, wherein the generating the labeled data further comprises annotating each sentence included in the input text data to recognize the named entity and mark the named entity with a corresponding label and position information of the named entity in each sentence.

5. The method of claim 1, further comprising:
pre-training, by the processing system, a first machine learning model that implements the few-shot learning algorithm using a train dataset, wherein the train dataset is greater than the plurality of few-shot examples; and
fine-tuning the first machine learning model using the plurality of few-shot examples.

6. The method of claim 3, further comprising training a first machine learning model that implements the prompt-free few-shot learning algorithm by:
tokenizing each sentence included in the input text data into one or more tokens;
generating a template for each of the one or more tokens;
sampling a first pair including a positive template and the template and a second pair including a negative template and the template from a templates pool;
sampling a third pair including a positive sentence template and the template and a fourth pair including a negative sentence template and the templates for each token;
fine-tuning the first machine learning model based on the first pair, the second pair, the third pair and the fourth pair; and
training a classification head of the first machine learning model.

7. The method of claim 6, further comprising:
receiving, by the processing system, a new input sentence;
tokenizing, by the processing system, the new input sentence;
converting, by the processing system, the new input sentence into a templates set, each template of the templates set corresponding to each token of the new input sentence;
predicting, by the processing system, a label and position information on each token of the new input sentence using the trained and fine-tuned first machine learning model;
aggregating, by the processing system, the predicted label and position information; and
generating a final output.

8. The method of claim 1, further comprising:
training, by the processing system, a second machine learning model that implements the confident learning based label noise detection algorithm; and
predicting and identifying, by the processing system, a label noise on the labeled data with the trained second machine learning model.

9. A non-transitory machine-readable medium, comprising executable instructions that, when executed by a processing system including a processor, facilitate performance of operations, the operations comprising:
training a first machine learning model to recognize a predetermined named entity in a sentence and a corresponding label;
receiving input sentences including a target named entity;
receiving a plurality of few-shot examples in a support set, the plurality of few-shot examples including an annotated label for the target named entity;
performing annotation on the input sentences with the trained first machine learning model using the plurality of few-shot examples and using no prompt;
generating labeled data including the annotated input sentences;
performing post-annotation on the labeled data with a second machine learning model that performs confident learning based label noise detection; and
generating cleaned labeled data excluding one or more noisy labels from the labeled data.

10. The non-transitory machine-readable medium of claim 9, wherein the training the first machine learning model further comprises:
tokenizing each sentence included in training input sentences into one or more tokens;
generating a template for each of the one or more tokens;
sampling a first pair including a positive template and the template and a second pair including a negative template and the template from a templates pool; and
sampling a third pair including a positive sentence template and the template and a fourth pair including a negative sentence template and the templates for each token.

11. The non-transitory machine-readable medium of claim 10, wherein the training the first machine learning model further comprises:
fine-tuning the first machine learning model based on the first pair, the second pair, the third pair and the fourth pair; and
training a classification head of the first machine learning model.

12. The non-transitory machine-readable medium of claim 11, wherein the operations further comprise:
receiving a new input sentence;
tokenizing the new input sentence;
converting the new input sentence into a templates set, each template of the templates set corresponding to each token of the new input sentence; and
predicting a label and position information on each token of the new input sentence using the trained first machine learning model.

13. The non-transitory machine-readable medium of claim 12, wherein the operations further comprise:
aggregating the predicted label and position information to form a final output; and
generating the final output.

14. The non-transitory machine-readable medium of claim 9, wherein the operations further comprise:
training the second machine learning model that performs the confident learning based label noise detection; and
predicting and identifying a label noise on the labeled data with the trained second machine learning model.

15. The non-transitory machine-readable medium of claim 9, wherein the generating the labeled data further comprises annotating each sentence to recognize the target named entity and mark the target named entity with a corresponding label and position information.

16. A device, comprising:
a processing system including a processor; and
a memory that stores executable instructions that, when executed by the processing system, facilitate performance of operations, the operations comprising:
training a few-shot learning model to recognize a predetermined named entity in a sentence and a corresponding label without a prompt;
receiving input sentences including a target named entity;
receiving a plurality of few-shot examples in a support set, the plurality of few-shot examples including annotated labels for the target named entity;
predicting annotation on the input sentences with the trained few-shot learning model;
generating labeled data including the annotated input sentences;
identifying a label noise on the labeled data using a confident learning based label noise detection model; and
generating cleaned labeled data excluding one or more noisy labels from the labeled data.

17. The device of claim 16, wherein the few-shot learning model further comprises a sentence transformer that encodes each input sentence to a fixed length vector.

18. The device of claim 16, wherein the predicting the annotation further comprises:
converting each input sentence into a templates set, each template of the templates set corresponding to each token of each of the input sentences; and
predicting a label and position information on each token of each input sentence using the trained few-shot learning model.

19. The device of claim 18, wherein the operations further comprise:
aggregating the predicted label and position information to form a final output; and
generating the final output.

20. The device of claim 16, wherein the operations further comprise:
training the confident learning based label noise detection model; and
predicting and identifying a label noise on the labeled data with the trained confident learning based label noise model.
